(19) United States
(12) Patent Application Publication
(10) Pub. No.: US 2005/0073395 A1
(43) Pub. Date: Apr. 7, 2005

(54) Method of disabling a stolen car utilizing a pager

(76) Inventor: Young Ill Choi, Burbank, CA (US)

Correspondence Address: Eugene Oak, Ph.D., J.D.;Patent Attorney, 610 S. Van Ness Ave., Los Angeles, CA, 90005, US

(21) Appl. No.: 10/679,172

(22) Filed: Oct. 6, 2003

(51) Int. Cl. B60R 25/10

(52) U.S. Cl. 340/426.11; 307/10.2

(57) ABSTRACT

A remote-controlled car disabling system for stolen cars is comprised of a pager, an ignition-killing switch, and an emergency brake system utilizing either a bullet or double blade jack knife. The disabling system is activated when the owner dials the pager number and an additional secret code.

### FIELD OF THE INVENTION

The present invention generally relates to a disabling method for a stolen car in a secluded location.

### BACKGROUND OF THE INVENTION

When a car owner realizes that his or her car is stolen and it is out of sight or the robber is just driving the car away, the owner wants to stop it immediately, without a chase, wherever the car may be at that moment. Currently, the procedure to stop a stolen car is to compare the plate number of a suspicious car with a stolen car list on the police computer, and then to ask the driver of the car to stop using the speaker of the police car. The driver will react in one of two ways: They will either follow the request of the police or attempt to escape by driving at high speeds. In the second case, the driver of the stolen car hopes to evade the police. However, as seen many times on the news, the police never give up chasing them. It creates an extremely dangerous situation and many innocent people are put in jeopardy. It is purpose of this invention to avoid this dangerous situation and stop the stolen car without any unnecessary accidents. The method and the means introduced by this invention will stop the stolen car immediately wherever the stolen car may be located. The method and the means introduced by this invention will disable the stolen car even though the thief changes the number plate or the painting of the car.

### DESCRIPTION OF THE PRIOR ARTS

U.S. Pat. No. 5,432,495 to Tompkins illustrates a beeper controlled auto security system in which a vehicle disabling device such as an ignition kill switch is selectively activated either by a hand held radio frequency transmitter unit or a beeper paging system satellite transmission initiated by a telephone call which may be at a very remote location from the vehicle. A vehicle motion detector turns on a monitor transmitter if the vehicle is thereafter moved, enabling detection by a portable monitor receiver carried by the vehicle owner or police vehicles. However, most car thieves can easily open the door, turn on the ignition switch and drive away.

U.S. Pat. No. 6,028,506 to Xiao introduces a car alarm transmitting and paging system comprising an improvement of an existing conventional phone pager and transmitter which allows the pager to be used dually as a phone pager and also as an alarm activation notification device, wherein the transmitter is used in conjunction with a conventional vehicle alarm to transmit the notification of alarm activation to the carrier of the modified pager. Because the modified pager still accepts incoming calls and operates as a conventional pager, this invention obviates the necessity of owning and carrying two separate pagers, one for normal pager use, and the other for notification of alarm activation.

Most car thieves can easily turn off the alarm, even though the car is running on a highway.

None of the prior art discloses such a perfect disabling method of disabling a stolen car wherever the stolen car may locate.

### SUMMARY OF THE INVENTION

The method to stop a stolen car utilizes a pager set behind the driver's gauge board. The method is comprised of three steps: 1) Confirming that the car is stolen, 2) Dialing the number of the pager installed in the stolen car, and 3) Entering a secret number to activate the trigger of the three stopping methods of this invention. The three stopping methods are: a) turning off the engine by cutting the electricity supplied to the engine, b) puncturing the rear tires with pistol bullets or jack knives which are installed inside of rear wheel cover, and c) activating a car alarm. When a car owner realizes his or her car is stolen, the car owner will activate the trigger of the stolen car by dialing the number the pager installed in the stolen car and a secret code. The stolen car will stop immediately by means of a combination of the stopping methods, i.e., the engine of the stolen car will stop, the rear tires will be punctured by one of the puncturing means, and car alarm will go off.

### BRIEF DESCRIPTION OF THE DRAWINGS

FIG. 1 is a schematic diagram of stopping stolen car disabling mechanism.

FIG. 2 is a perspective view of the pager installed behind the gauge board of a car.

FIG. 3 is a schematic logical diagram of stolen car disabling method.

FIG. 4 is a schematic diagram of first disabling means; turning off the car's engine.

FIG. 5-a is a schematic diagram of second disabling means; puncturing rear tires with bullet.

FIG. 5-b is a schematic diagram of another embodiment of the second disabling means; puncturing rear tires with jack knives.

FIG. 6 is a schematic diagram of third disabling means; activating the car's anti-theft alarm.

### DETAILED DESCRIPTION OF THE PREFERRED EMBODIMENT

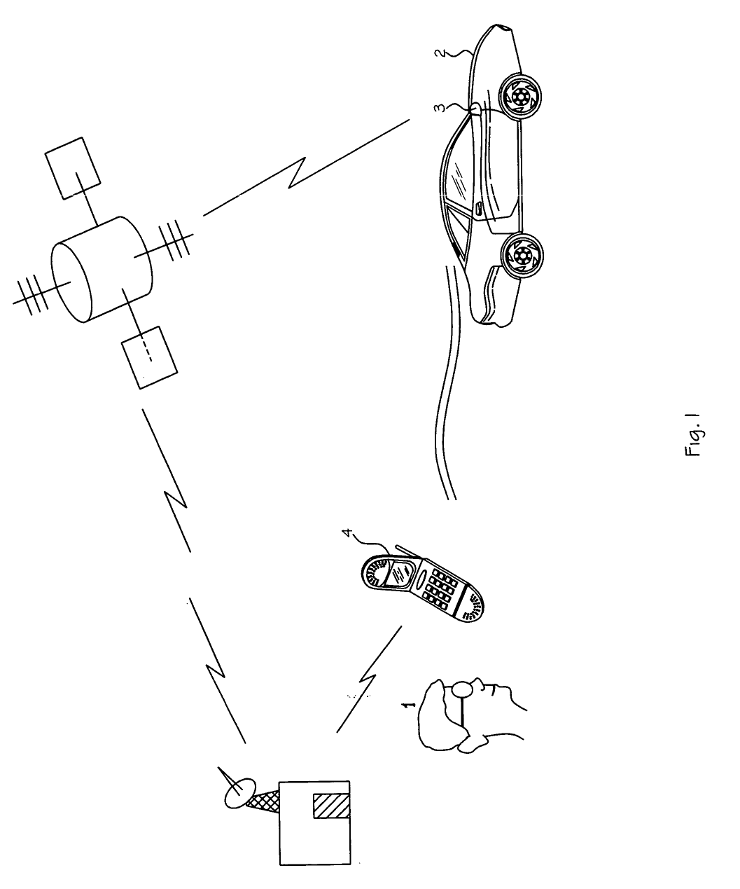

FIG. 1 is a schematic diagram of a disabling mechanism for a stolen car. When a car owner (1) finds that his or her car (2) is out of sight and confirms that the car (2) is stolen, then the owner (1) dials the number of pager (3) embedded in the stolen car (2) on any telephone (4).

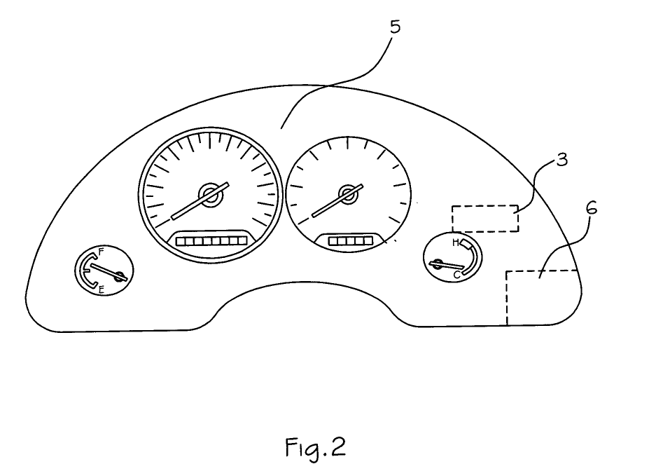

The pager (3) used for the above purpose is installed behind the driving gauge board (5) as shown in FIG. 2.

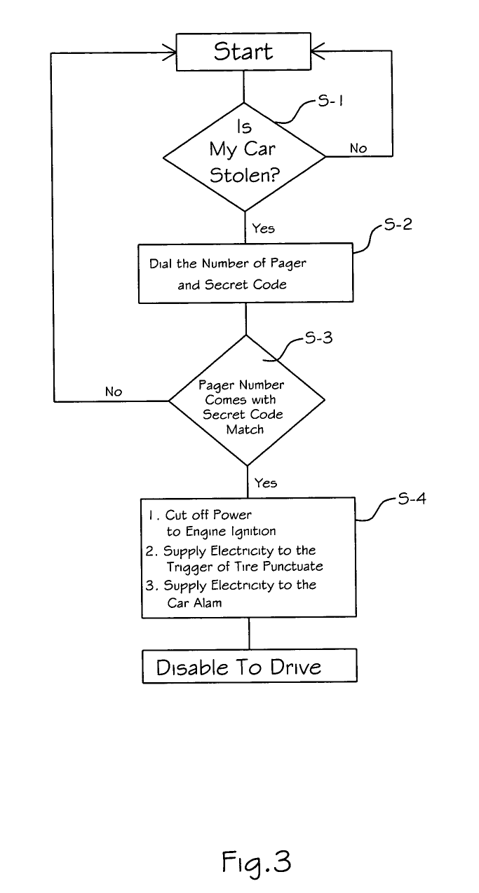

FIG. 3 is a schematic logic diagram of stolen car disabling method. When a car owner (1) confirms that his or her car (2) is stolen in step S-1, he/she dials the number of pager and secret code in step S-2. The pager number and the secret number are compared in step S-3 by the main processor of the stolen car (2). Even though someone besides the owner (1) dials the pager number by mistake, the disabling mechanism will not be in operational mode without the secret code.

If the pager number and secret code match the numbers memorized in the computer, the main computer (6) of the stolen car (2) sends an activating signal for the disabling means in step S-4.

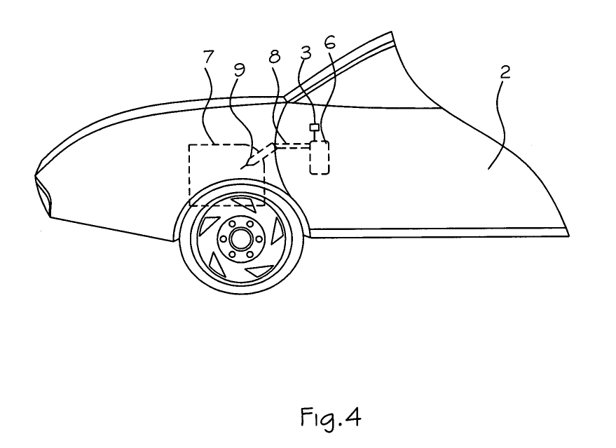

The three disabling means are illustrated as follows. The first one is to disconnect the electric power supply to the ignition plug of the car's engine (7) as shown in FIG. 4. For this purpose, the main computer (6) of the stolen car (2) is connected to the pager (3) for receiving the pager number and secret code. The main computer (6) has a program to disconnect the power supply (8) to the ignition plug (9) activated by the pager number and secrete code.

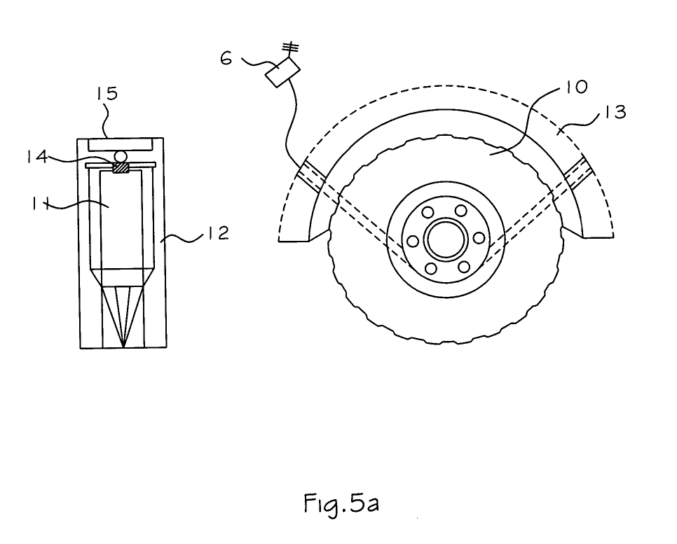

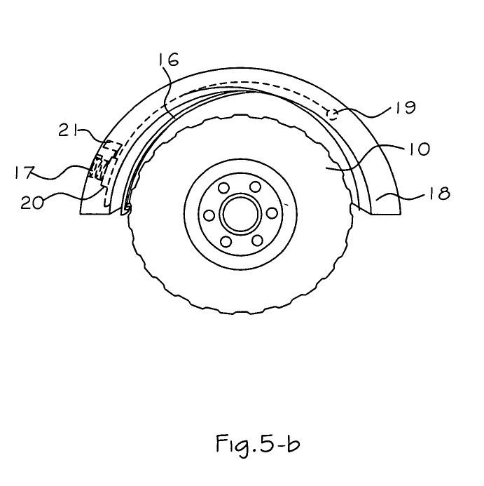

The second disabling system works by puncturing both of the rear tires with pistol bullets or jack knives. FIG. 5-a is a schematic drawing of the system of puncturing rear tires (10) with bullet (11). Two sets of one bullet (11) in a short barrel (12) are installed inside of one rear wheel cover (13). Another two sets of bullets (11) in a short barrel (12) are installed inside of the opposite rear wheel cover. The shooting (14) of the bullet (11) is connected to an electric trigger line (15). The electric trigger line is connected to the main computer (6) of FIG. 4.

FIG. 5-b is a schematic drawing of the system of puncturing rear tires (10) with a hook blade (16). One hook blade (16) connected to a spring (17) is installed inside of rear wheel cover. Another set of hook blade (16) connected to a spring (17) is installed inside of the opposite rear wheel cover. One end of the hook blade (16) is pivotally affixed to the rear wheel cover (18) with a bolt and nut (19). The other side of the hook blade (16) is captured by a trigger (20), which is connected to an electric trigger line (21). The electric trigger line is connected to the main computer (6) of FIG. 4.

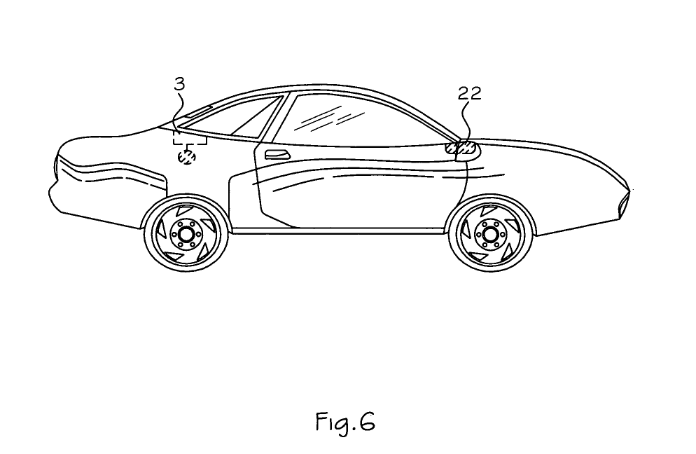

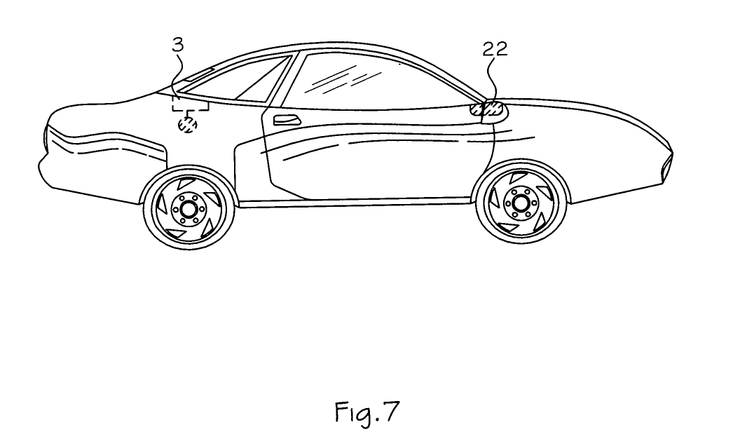

FIG. 6 is a schematic drawing of the anti-theft alarm connected to the pager.

If all of the three disabling systems are activated, recovering the damage will require a great deal time and money. Therefore, the value of the car to the thief will decrease while the chance of getting caught will increase. Therefore, the only option for the thief is to abandon the car.

1. A disabling method and system of a stolen car is comprised of 1) disabling the car engine by disconnecting the electric power supply to the ignition plug according to the order of the main computer, 2) puncturing rear tires with two sets of bullets, which is connected to an electric trigger line connected to the main computer in a short barrel installed at the inside of one rear wheel cover and another two sets of bullets in a short barrel installed at the inside of the opposite rear wheel cover, and 3) activating the anti-theft alarm which is connected to the main computer by dialing the number of a pager which is installed behind the driving gauge board and a secret code with conventional telephone.

2. A disabling method and system of a stolen car comprised of 1) disabling the car engine by disconnecting the electric power supply to the ignition plug according to the order of the main computer, 2) puncturing rear tires with hook blade which is connected to a spring and one end of the hook blade is pivotally affixed to the rear wheel cover with bolt and nut, installed at the inside of rear wheel cover and another set of hook blade also connected to a spring is installed at the inside of another rear wheel cover of opposite site and the other side of the hook blade is captured by a trigger which is connected to an electric trigger line which is connected to the main computer (6) of FIG. 4, and 3) activating the anti-theft alarm which is connected to the main computer by dialing the number of a pager, which is installed behind the driving gauge board, and a secret code with conventional telephone.
